(19) United States
(12) Patent Application Publication
(10) Pub. No.: US 2020/0148013 A1
(43) Pub. Date: May 14, 2020

(54) PUNCTURE RESISTANT TIRE HAVING A SPIRAL-ON PLY

(71) Applicant: Bridgestone Americas Tire Operations, LLC, Nashville, TN (US)

(72) Inventors: David J. Zemla, Canal Fulton, OH (US); James M. Kirby, Akron, OH (US); Kathleen A. Clemmer, Akron, OH (US)

(21) Appl. No.: 16/631,854

(22) PCT Filed: Jul. 11, 2018
(86) PCT No.: PCT/US18/41618

§ 371 Date: Jan. 17, 2020

Related U.S. Application Data
(60) Provisional application No. 62/534,721, filed on Jul. 20, 2017.

(51) Int. Cl. B60C 19/12; B60C 9/20

(52) U.S. Cl. CPC B60C 19/12; B60C 9/0042; B60C 9/20

(57) ABSTRACT

A pneumatic tire having an increased resistance to punctures. The pneumatic tire may have at least one puncture resistant ply constructed from a fiber reinforcement oriented circumferentially around the tire and providing circumferential reinforcement. The fiber reinforcement may be spirally wound around the carcass of the tire, wherein adjacent edges of the fiber reinforcement may overlap to form a continuous puncture resistant ply across the axial width of a crown portion of the tire. The pneumatic tire may incorporate at least one puncture resistant ply in place of at least one belt to provide both circumferential reinforcement and puncture resistance for the pneumatic tire.

### BACKGROUND

Since the introduction of the pneumatic tire, there has been a need for a pneumatic tire that is resistant to punctures. Accordingly, various materials and constructions have been proposed, with varying degrees of success. One of the challenges that has made it difficult to solve this problem is finding an adequate balance between puncture resistance, rolling resistance, weight, stiffness, flexibility, and durability.

For example, materials that provide adequate puncture resistance may be too heavy or too stiff and result in a tire having insufficient rolling resistance or durability. By contrast, materials that provide adequate rolling resistance and durability may have insufficient puncture resistance.

One solution may be to provide a pneumatic tire with an inner liner to contain the pressurized air and a reinforcement layer to provide puncture resistance. The reinforcement layer providing puncture resistance may be selected solely for the purpose of preventing punctures. However, the reinforcement layer may also be selected to provide radial or circumferential reinforcement.

For example, a pneumatic tire may have a butyl inner liner on its radially innermost surface. The tire may also have a carcass made from body plies that provide radial support. The tire may also have a belt made from belt plies that provide circumferential support. The tire may include an additional reinforcement made from materials that primarily provide puncture resistance. Optionally, the body plies and/or the belt plies may be made from materials that, in addition to their primary functions of providing for radial reinforcement and circumferential reinforcement, respectively, also provide resistance to punctures.

What is needed is a pneumatic tire that adequately balances puncture resistance with rolling resistance, weight, stiffness, flexibility, and durability.

### SUMMARY

In one embodiment, a pneumatic tire may have a first sidewall portion extending radially from a first bead portion to a first shoulder portion, a second sidewall portion extending radially from a second bead portion to a second shoulder portion, a tread portion oriented axially between the first shoulder portion and the second shoulder portion, and at least one body ply extending radially from about the first bead portion, through the tread portion, to about the second bead portion. The at least one body ply may provide radial reinforcement. At least one puncture resistant ply may be located within the tread portion. The at least one puncture resistant ply may be oriented radially outward of the at least one body ply. The at least one puncture resistant ply may have at least one continuous puncture resistant strip spirally-wound circumferentially around the at least one body ply. Adjacent passes of the continuous puncture resistant strip may be axially offset from one another by a distance of between about 10% and about 90% of their axial widths. The at least one puncture resistant ply may provide circumferential reinforcement and may include a fiber reinforcement having a fiber having a weight greater than 15 denier.

In another embodiment, a pneumatic tire may have a first sidewall portion extending radially from a first bead portion to a first shoulder portion, a second sidewall portion extending radially from a second bead portion to a second shoulder portion, a tread portion oriented axially between the first shoulder portion and the second shoulder portion, and at least one body ply extending radially from about the first bead portion, through the tread portion, to about the second bead portion. The at least one body ply may provide radial reinforcement. At least one belt may be locate within the tread portion. The at least one belt may be oriented radially outward of the at least one body ply and may extend circumferentially around the tire. The at least one belt may provide circumferential reinforcement. At least one puncture resistant ply may be located within the tread portion. The at least one puncture resistant ply may be oriented radially outward of the at least one belt and may extend circumferentially around the tire. The at least one puncture resistant ply may have at least one continuous puncture resistant strip spirally-wound circumferentially around the at least one belt. Adjacent passes of the continuous puncture resistant strip may be axially offset from one another by a distance of between about 10% and about 90% of their axial widths. The at least one puncture resistant ply may provide circumferential reinforcement and may include a fiber reinforcement having a fiber having a weight greater than 15 denier.

In another embodiment, a pneumatic tire may have a first sidewall portion extending radially from a first bead portion to a first shoulder portion, a second sidewall portion extending radially from a second bead portion to a second shoulder portion, and a tread portion having a tread width TW. The tread portion may be oriented axially between the first shoulder portion and the second shoulder portion. At least one body ply may extend radially from about the first bead portion, through the tread portion, to about the second bead portion. The at least one body ply may provide radial reinforcement. At least one belt having a belt width BW may be located within the tread portion. The at least one belt may be oriented radially outward of the at least one body ply and may extend circumferentially around the tire. The at least one belt may provide circumferential reinforcement. At least one puncture resistant ply having a width PW may be located within the tread portion. The at least one puncture resistant ply may be oriented radially outward of the at least one belt and may extend circumferentially around the tire. The at least one puncture resistant ply may have at least one continuous puncture resistant strip spirally-wound circumferentially around the at least one body ply. Adjacent passes of the continuous puncture resistant strip may be axially offset from one another by a distance of between about 10% and about 90% of their axial widths. The at least one puncture resistant ply may provide circumferential reinforcement. The at least one puncture resistant ply may include a fiber reinforcement having a fiber having a weight greater than 15 denier. At least one nylon ply having a width NW may be located in the tread portion. The at least one nylon ply may be oriented radially outward of the at least one puncture resistant ply and may extend circumferentially around the tire.

### BRIEF DESCRIPTION OF THE DRAWINGS

The accompanying figures, which are incorporated in and constitute a part of the specification, illustrate various example embodiments, and are used merely to illustrate various example embodiments. In the figures, like elements bear like reference numerals.

FIG. 1 illustrates a sectional view of a first embodiment of a pneumatic tire having a spiral-on puncture resistant ply.

FIG. 2 illustrates a sectional view of a second embodiment of a pneumatic tire having a spiral-on puncture resistant ply.

FIG. 3A illustrates a sectional view of an embodiment of a spiral-on puncture resistant ply.

FIG. 3B illustrates a plan view of an embodiment of a spiral-on puncture resistant ply.

FIG. 4 illustrates a sectional view of a third embodiment of a pneumatic tire having a spiral-on puncture resistant ply.

FIG. 5 illustrates a sectional view of a fourth embodiment of a pneumatic tire having a spiral-on puncture resistant ply.

### DETAILED DESCRIPTION

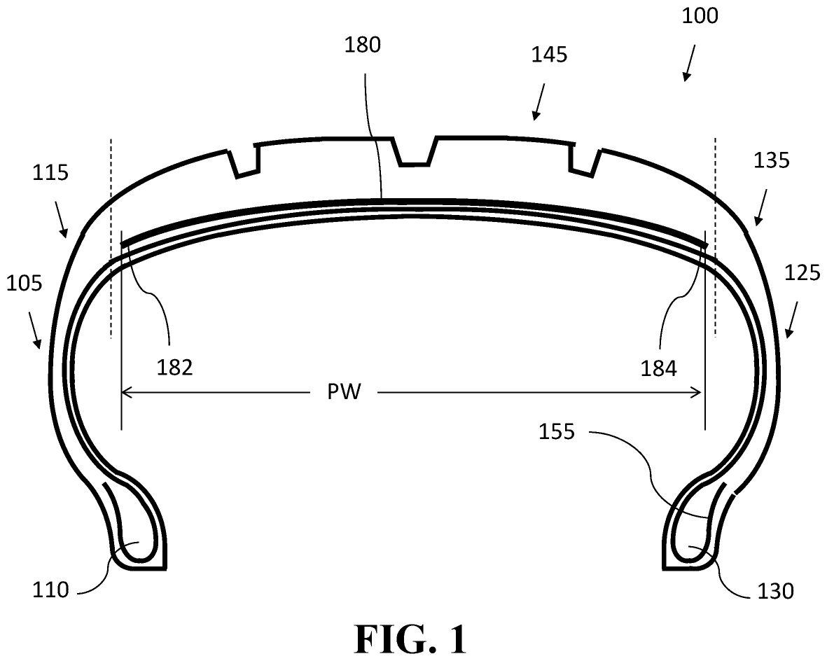

FIG. 1 illustrates a sectional view of an example embodiment of a tire 100. Tire 100 may have a first sidewall portion 105 extending radially from a first bead portion 110 to a first shoulder portion 115. Tire 100 may have a second sidewall portion 125 extending radially from a second bead portion 130 to a second shoulder portion 135. Tire 100 may have a tread portion 145 oriented axially between first shoulder portion 115 and second shoulder portion 135.

Tire 100 may be a pneumatic tire. In one embodiment, tire 100 may be a pneumatic tire designed for application to a vehicle. In another embodiment, tire 100 may be a pneumatic tire designed for application to a road vehicle. In one embodiment, tire 100 may be a non-directional tire, wherein tire 100 is configured to be mounted on a vehicle without a specified forward rolling direction. In another embodiment, tire 100 may be a unidirectional tire, wherein tire 100 is configured to be mounted on a vehicle with a specified forward rolling direction.

Tire 100 may have at least one body ply 155, which may comprise a reinforcement cord and a rubber skim. The reinforcement cord may be a fiber reinforcement cord. The reinforcement cord may be any of a variety of materials, including for example, polyester, rayon, nylon, aramid, and polyethylene naphthalate (PEN). The rubber skim may be any of a variety of rubber materials, having any of a variety of common formulations, densities, and other properties for use in tires.

Tire 100 may have at least one body ply 155 extending radially from at least partially around first bead portion 110, through tread portion 145, to at least partially around second bead portion 130. At least one body ply 155 may wrap at least partially around, approximately half way around, and/or around first bead portion 110 (creating a first turnup portion), extend radially through tread portion 145, and wrap at least partially around, approximately half way around, and/or around second bead portion 130 (creating a second turnup portion). At least one body ply 155 may provide radial reinforcement for tire 100. At least one body ply 155 may provide strength to contain the air pressure within tire 100 and may provide impact resistance in at least one of first sidewall portion 105 and second sidewall portion 125.

In one embodiment, the body plies of a tire are built on a cylindrical drum. In this embodiment, the bead rings of the tire are placed over the body plies, after which the area of the tire axially between the bead rings is radially expanded and greatly increased in diameter upon radial expansion of the cylindrical drum. In this embodiment, the portions of the body plies axially outside of the bead rings are turned up vertically roughly in the area of what will become the sidewalls of the tire. In this embodiment, after the tire is expanded in this manner, one or more belts are added. In this embodiment, this entire “green” tire is then placed in a mold and cured under heat and pressure. In this embodiment, the body plies of the tire must undergo significant circumferential and radial expansion during the building of the tire, thus the tire's belts must be applied after expansion of the tire because the belts do not appreciably expand, including circumferentially or radially.

Tire 100 may have at least one puncture resistant ply 180 located in tread portion 145. At least one puncture resistant ply 180 may be oriented radially inward of tread portion 145. At least one puncture resistant ply 180 may be oriented radially outward of at least one body ply 155.

At least one puncture resistant ply 180 may have axially opposing sides, such as a first side 182 and a second side 184. First side 182 may terminate axially inward of first shoulder portion 115. In one embodiment, second side 184 may terminate axially inward of second shoulder portion 135. The junction between tread portion 145 and first shoulder portion 115/second shoulder portion 135 may be denoted for example by a dashed line in FIG. 1.

At least one puncture resistant ply 180 may extend circumferentially around tire 100. At least one puncture resistant ply 180 may be formed as a rectangle (not shown). At least one puncture resistant ply 180 may be formed into a loop by abutting or overlapping opposing ends of the rectangle. The abutting or overlapping opposing ends of the rectangle may be attached or unattached to one another. The rectangle may have a width corresponding to an axial width PW of at least one puncture resistant ply 180. The rectangle may have a width greater than an axial width PW of at least one puncture resistant ply 180 to account for the curvature of puncture resistant ply 180. Axial width PW may be the distance from first side 182 to second side 184. The rectangle may have a length corresponding to the circumference of at least one puncture resistant ply 180. The rectangle may have a length that is greater than the circumference of at least one puncture resistant ply 180 in order to allow the opposing ends of at least one puncture resistant ply 180 to overlap when formed into a loop.

At least one puncture resistant ply 180 may be formed as a continuous loop. At least one puncture resistant ply 180 may have radially opposing surfaces. At least one puncture resistant ply 180 may have a radially inner surface and a radially outer surface. At least one puncture resistant ply 180 may have a centerline on the radial outer surface and/or on the radial inner surface such that the centerline is spaced an equal distance from each of first side 182 and second side 184.

At least one puncture resistant ply 180 may be made from a fiber reinforcement. The fiber reinforcement may be at least one of: a unidirectional fabric, a woven fabric, and a knitted fabric. The fiber reinforcement may have any orientation of fibers that provides for a mesh structure that allows for both open space between and movement among adjacent fibers. The fiber reinforcement may be selected for at least one of: its strength, its durability, its flexibility, its weight, its density, its adhesion to other materials, its puncture resistance, and the like.

The puncture resistance of at least one puncture resistant ply 180 may be provided by a fiber reinforcement having a mesh structure of adjacent fibers that are sufficiently close to one another so as to prevent a foreign object from penetrating the mesh structure. The flexibility of at least one puncture resistant ply 180 may be provided by a fiber reinforcement having a mesh structure of adjacent fibers that are sufficiently free to allow movement among one another.

The fiber reinforcement of at least one puncture resistant ply 180 may be used to reinforce another material, such as a polymer. Suitable polymers may include elastomers, such as but not limited to, natural rubbers, synthetic rubbers, and thermoplastic elastomers. The material reinforced by the fiber reinforcement is not limited and may be selected from any material depending upon the needs of the application in accordance with contemporary design, engineering, materials science principles, and the like. The fiber reinforcement may be used to reinforce any material suitable for use in a tire.

The adhesion of the fiber reinforcement to the material it reinforces may be promoted by allowing sufficient space between adjacent fibers of the mesh structure for the material to penetrate. For example, a polymer may adhere better to a mesh structure having larger spaces between adjacent fibers than the polymer may adhere to a mesh structure having smaller spaces between adjacent fibers.

At least one puncture resistant ply 180 may require an ideal balance between adhesion to a material, such as a polymer, and puncture resistance. For example, if the adjacent fibers of the mesh structure are too close together, a material may adhere poorly to the mesh structure because the material may be unable to penetrate into the small spaces between adjacent fibers. However, such an arrangement may provide for excellent puncture resistance because the close proximity of the adjacent fibers of the mesh structure may prevent objects from penetrating the mesh structure. By contrast, if the adjacent fibers of the mesh structure are farther apart, a material may have excellent adherence to the mesh structure because the material may be able to sufficiently penetrate into the larger spaces between adjacent fibers. However, such an arrangement may provide for poor puncture resistance because the larger spaces between the adjacent fibers of the mesh structure may allow objects to penetrate the mesh structure.

At least one puncture resistant ply 180 may be substantially puncture resistant. At least one puncture resistant ply 180 may be made from a fiber reinforcement selected for its flexibility and/or its puncture resistance. At least one puncture resistant ply 180 may be made from a fiber reinforcement having a mesh structure that is sufficiently open to allow the material it reinforces to properly adhere to the mesh structure, while simultaneously being sufficiently closed to prevent objects from penetrating the mesh structure.

At least one puncture resistant ply 180 may include a fiber reinforcement comprising a fiber having a weight greater than 15 (or about 15) denier. At least one puncture resistant ply 180 may include a fiber reinforcement comprising a fiber having a weight between 500 (or about 500) denier and 1500 (or about 1500) denier. At least one puncture resistant ply 180 may include a fiber reinforcement comprising a fiber having a weight between 700 (or about 700) denier and 1200 (or about 1200) denier. At least one puncture resistant ply 180 may include a fiber reinforcement comprising a fiber having a weight between 840 (or about 840) denier and 1050 (or about 1050) denier. At least one puncture resistant ply 180 may include a fiber reinforcement comprising a fiber having a weight of at least one of: 840 (or about 840) denier and 1050 (or about 1050) denier.

At least one puncture resistant ply 180 may include a fiber reinforcement comprising a nylon fiber. At least one puncture resistant ply 180 may include a fiber reinforcement comprising nylon 66. At least one puncture resistant ply 180 may include a fiber reinforcement comprising an aramid fiber. At least one puncture resistant ply 180 may include a fiber reinforcement comprising a synthetic fiber. At least one puncture resistant ply 180 may include a fiber reinforcement comprising a natural fiber. At least one puncture resistant ply 180 may include a fiber reinforcement comprising a monofilament fiber. At least one puncture resistant ply 180 may include a fiber reinforcement comprising a multifilament fiber.

At least one puncture resistant ply 180 may include a fiber reinforcement comprising a nylon fiber having a weight between 700 (or about 700) denier and 1200 (or about 1200) denier. At least one puncture resistant ply 180 may include a fiber reinforcement comprising a nylon fiber having a weight of 840 (or about 840) denier. At least one puncture resistant ply 180 may include a fiber reinforcement comprising a nylon fiber having a weight of 1050 (or about 1050) denier. The fiber reinforcement may be made from a nylon fiber that is knitted and has both warp and fill weights of 840 (or about 840) denier. The fiber reinforcement may be made from a nylon fiber that is knitted and has both warp and fill weights of 1050 (or about 1050) denier. The fiber reinforcement may be made from a nylon fiber that is knitted and has a warp weight of 840 (or about 840) denier and has a fill weight of 1050 (or about 1050) denier. The fiber reinforcement may be made from a nylon fiber that is knitted and has a warp weight of 1050 (or about 1050) denier and has a fill weight of 840 (or about 840) denier.

In one embodiment, at least one puncture resistant ply 180 may include a fiber reinforcement having between 20 (or about 20) ends per inch and 25 (or about 25) ends per inch (7.5 (or about 7.5) ends per cm. and 10.0 (or about 10.0) ends per cm.). The fiber reinforcement may have between 21 (or about 21) ends per inch and 23 (or about 23) ends per inch (8.0 (or about 8.0) ends per cm. and 9.5 (or about 9.5) ends per cm.). The fiber reinforcement may have 21 (or about 21) ends per inch (8.0 (or about 8.0) ends per cm.). The fiber reinforcement may have 22 (or about 22) ends per inch (8.5 (or about 8.5) ends per cm.). The fiber reinforcement may have 23 (or about 23) ends per inch (9.5 (or about 9.5) ends per cm.).

In one embodiment, at least one puncture resistant ply 180 may include a fiber reinforcement having between 35 (or about 35) ends per inch and 45 (or about 45) ends per inch (13.5 (or about 13.5) ends per cm. and 18.0 (or about 18.0) ends per cm.). The fiber reinforcement may have between 39 (or about 39) ends per inch and 41 (or about 41) ends per inch (15.0 (or about 15.0) ends per cm. and 16.5 (or about 16.5) ends per cm.). The fiber reinforcement may have 39 (or about 39) ends per inch (15.0 (or about 15.0) ends per cm.). The fiber reinforcement may have 40 (or about 40) ends per inch (15.5 (or about 15.5) ends per cm.). The fiber reinforcement may have 41 (or about 41) ends per inch (16.5 (or about 16.5) ends per cm.).

In one embodiment, at least one puncture resistant ply 180 may include a fiber reinforcement having between 15 (or about 15) picks per inch and 20 (or about 20) picks per inch (5.5 (or about 5.5) picks per cm. and 7.5 (or about 7.5) picks per cm.). The fiber reinforcement may have between 16 (or about 16) picks per inch and 18 (or about 18) picks per inch (6.0 (or about 6.0) picks per cm. and 7.0 (or about 7.0) picks per cm.). The fiber reinforcement may have 16 (or about 16) picks per inch (6.0 (or about 6.0) picks per cm.). The fiber reinforcement may have 17 (or about 17) picks per inch (6.5 (or about 6.5) picks per cm.). The fiber reinforcement may have 18 (or about 18) picks per inch (7.0 (or about 7.0) picks per cm.).

In one embodiment, at least one puncture resistant ply 180 may include a fiber reinforcement having between 35 (or about 35) picks per inch and 45 (or about 45) picks per inch (13.5 (or about 13.5) picks per cm. and 18.0 (or about 18.0) picks per cm.). The fiber reinforcement may have between 39 (or about 39) picks per inch and 41 (or about 41) picks per inch (15.0 (or about 15.0) picks per cm. and 16.5 (or about 16.5) picks per cm.). The fiber reinforcement may have 39 (or about 39) picks per inch (15.0 (or about 15.0) picks per cm.). The fiber reinforcement may have 40 (or about 40) picks per inch (15.5 (or about 15.5) picks per cm.). The fiber reinforcement may have 41 (or about 41) picks per inch (16.5 (or about 16.5) picks per cm.).

In one embodiment, at least one puncture resistant ply 180 may include a fiber reinforcement comprising a fiber having a gauge between 0.010 (or about 0.010) inch and 0.020 (or about 0.020) inch (0.25 (or about 0.25) mm and 0.51 (or about 0.51) mm). The fiber reinforcement may be made from a fiber having a gauge between 0.014 (or about 0.014) inch and 0.018 (or about 0.018) inch (0.35 (or about 0.35) mm and 0.46 (or about 0.46) mm). The fiber reinforcement may be made from a fiber having a gauge of 0.014 (or about 0.014) inch (0.35 (or about 0.35) mm). The fiber reinforcement may be made from a fiber having a gauge of 0.016 (or about 0.016) inch (0.41 (or about 0.41) mm). The fiber reinforcement may be made from a fiber having a gauge of 0.018 (or about 0.018) inch (0.46 (or about 0.46) mm).

In one embodiment, at least one puncture resistant ply 180 may include a fiber reinforcement comprising a fiber having a gauge between 0.025 (or about 0.025) inch and 0.035 (or about 0.035) inch (0.63 (or about 0.63) mm and 0.89 (or about 0.89) mm). The fiber reinforcement may be made from a fiber having a gauge between 0.027 (or about 0.027) inch and 0.031 (or about 0.031) inch (0.68 (or about 0.68) mm and 0.79 (or about 0.79) mm). The fiber reinforcement may be made from a fiber having a gauge of 0.027 (or about 0.027) inch (0.68 (or about 0.68) mm). The fiber reinforcement may be made from a fiber having a gauge of 0.029 (or about 0.029) inch (0.74 (or about 0.74) mm). The fiber reinforcement may be made from a fiber having a gauge of 0.031 (or about 0.031) inch (0.79 (or about 0.79) mm)

In one embodiment, at least one puncture resistant ply 180 may include a fiber reinforcement having a maximum shrinkage of between 1.0% (or about 1.0%) and 3.0% (or about 3.0%). The fiber reinforcement may have a maximum shrinkage of between 1.5% (or about 1.5%) and 2.5% (or about 2.5%). The fiber reinforcement may have a maximum shrinkage of 2.5% (or about 2.5%). The fiber reinforcement may have a maximum shrinkage max of 1.5% (or about 1.5%).

In one embodiment, at least one puncture resistant ply 180 may include a fiber reinforcement having a weight per sq. yd. of 4.0 (or about 4.0) oz. to 6.0 (or about 6.0) oz. (weight per sq. m. of 135 (or about 135) g. to 204 (or about 204) g.). The fiber reinforcement may have a weight per sq. yd. of 4.9 (or about 4.9) oz. to 5.3 (or about 5.3) oz. (weight per sq. m. of 166 (or about 166) g. to 180 (or about 180) g.). The fiber reinforcement may have a weight per sq. yd. of 4.9 (or about 4.9) oz. (weight per sq. m. of 166 (or about 166) g.). The fiber reinforcement may have a weight per sq. yd. of 5.1 (or about 5.1) oz. (weight per sq. m. of 173 (or about 173) g.). The fiber reinforcement may have a weight per sq. yd. of 5.3 (or about 5.3) oz. (weight per sq. m. of 180 (or about 180) g.).

In one embodiment, at least one puncture resistant ply 180 may include a fiber reinforcement having a weight per sq. yd. of 10.0 (or about 10.0) oz. to 15.0 (or about 15.0) oz. (weight per sq. m. of 339 (or about 339) g. to 509 (or about 509) g.). The fiber reinforcement may have a weight per sq. yd. of 11.7 (or about 11.7) oz. to 12.4 (or about 12.4) oz. (weight per sq. m. of 397 (or about 397) g. to 420 (or about 420) g.). The fiber reinforcement may have a weight per sq. yd. of 11.7 (or about 11.7) oz. (weight per sq. m. of 397 (or about 397) g.). The fiber reinforcement may have a weight per sq. yd. of 12.05 (or about 12.05) oz. (weight per sq. m. of 409 (or about 409) g.). The fiber reinforcement may have a weight per sq. yd. of 12.4 (or about 12.4) oz. (weight per sq. m. of 420 (or about 420) g.).

At least one puncture resistant ply 180 may include a fabric reinforcement having a minimum tensile strength in both the warp and the fill directions of greater than 300 (or about 300) lbf (1334 N). The fabric reinforcement may have a minimum tensile strength in both the warp and the fill directions of greater than 400 (or about 400) lbf (1779 N). The fabric reinforcement may have a minimum tensile strength in both the warp and the fill directions of greater than 500 (or about 500) lbf (2224 N). The fabric reinforcement may have a minimum tensile strength in both the warp and the fill directions of greater than 600 (or about 600) lbf (2669 N). The fabric reinforcement may have a minimum tensile strength in at least one of the warp direction and the fill direction of 375 (or about 375) lbf (1668 N). The fabric reinforcement may have a minimum tensile strength in at least one of the warp direction and the fill direction of 400 (or about 400) lbf (1779 N). The fabric reinforcement may have a minimum tensile strength in at least one of the warp direction and the fill direction of 650 (or about 650) lbf (2891 N).

At least one puncture resistant ply 180 may include a fabric reinforcement having a minimum warp adhesion of greater than 10 (or about 10) lbf (44 N). The fabric reinforcement may have a minimum warp adhesion of 15 (or about 15) lbf (67 N).

In one embodiment, at least one puncture resistant ply 180 may be used as a replacement for a belt (not shown). For example, at least one puncture resistant ply 180 may provide sufficient circumferential reinforcement for tire 100 such that a belt may not be necessary. Such an arrangement of tire 100 may at least one of: save weight, reduce rolling resistance, improve ride comfort, increase durability, improve handling, increase fuel efficiency, and the like.

In one embodiment, tire 100 may have more than one puncture resistant ply 180. In one embodiment, tire 100 may have as many puncture resistant plies 180 as necessary to achieve the desired design goals for tire 100.

At least one puncture resistant ply 180 may provide for puncture resistance of tire 100 in tread portion 145. The position of at least one puncture resistant ply 180 may be modified so as to control the area of tire 100 in which puncture resistance is required. For example, puncture resistance may be required in at least one of: first sidewall portion 105, first shoulder portion 115, second sidewall portion 125, second shoulder portion 135, and tread portion 145.

However, in some cases, it may be important to have puncture resistance only in tread portion 145. For example, it may be possible to safely repair a puncture located in tread portion 145 because the construction of tread portion 145 may be less likely to lead to a catastrophic failure of tire 100 than when punctures occur in other locations of tire 100, such as in the sidewall portions and in the shoulder portions. Consequently, it may not be possible to safely repair a puncture located in the sidewall portions or the shoulder portions of tire 100 because such punctures may be more likely to lead to a catastrophic failure of tire 100. A catastrophic failure of tire 100 may be dangerous to an occupant of a vehicle (not shown), as well as to nearby pedestrians and to occupants of nearby vehicles. Thus, in one embodiment, at least one puncture resistant ply 180 may be positioned so as to provide puncture resistance only in tread portion 145. In one embodiment, at least one puncture resistant ply 180 may not extend into either the shoulder portions or the sidewall portions of tire 100.

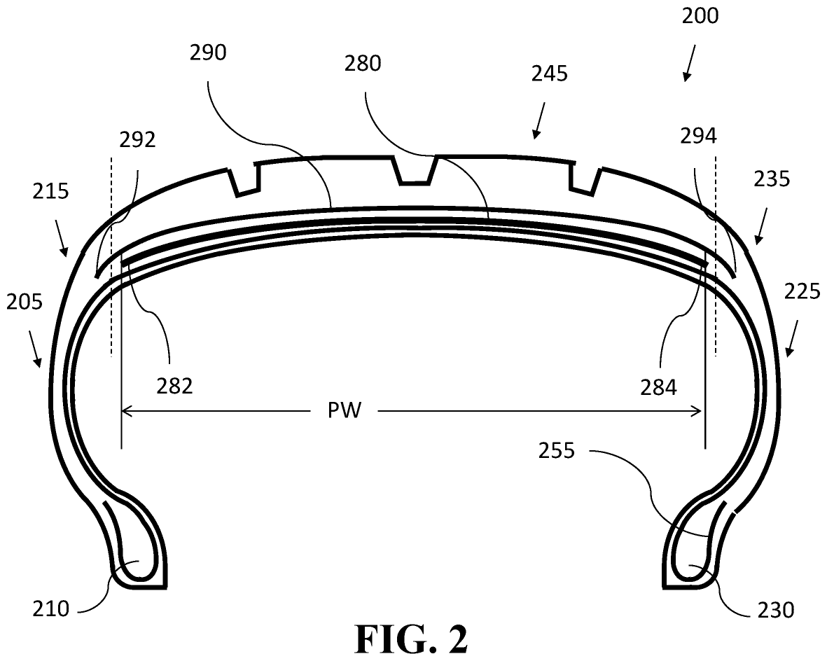

FIG. 2 illustrates a sectional view of an example embodiment of a tire 200. Tire 200 may have a first sidewall portion 205 extending radially from a first bead portion 210 to a first shoulder portion 215. Tire 200 may have a second sidewall portion 225 extending radially from a second bead portion 230 to a second shoulder portion 235. Tire 200 may have a tread portion 245 oriented axially between first shoulder portion 215 and second shoulder portion 235.

Tire 200 may have at least one body ply 255 extending radially from about first bead portion 210, through tread portion 245, to at least partially around second bead portion 230. At least one body ply 255 may wrap at least partially around first bead portion 210, approximately half way around, and/or around first bead portion 210 (creating a first turnup portion), extend radially through tread portion 245, and wrap at least partially around, approximately half way around, and/or around second bead portion 230 (creating a second turnup portion). At least one body ply 255 may provide radial reinforcement for tire 200. At least one body ply 255 may provide strength to contain the air pressure within tire 200 and may provide impact resistance in at least one of first sidewall portion 205 and second sidewall portion 225.

Tire 200 may have at least one puncture resistant ply 280 located in tread portion 245. At least one puncture resistant ply 280 may be oriented radially inward of tread portion 245. At least one puncture resistant ply 280 may be oriented radially outward of at least one body ply 255.

At least one puncture resistant ply 280 may have axially opposing sides, such as a first side 282 and a second side 284. In one embodiment, first side 282 may terminate axially inward of first shoulder portion 215. In one embodiment, second side 284 may terminate axially inward of second shoulder portion 235. The junction between tread portion 245 and first shoulder portion 215/second shoulder portion 235 may be denoted for example by a dashed line in FIG. 2.

At least one puncture resistant ply 280 may extend circumferentially around tire 200. Puncture resistant ply 280 may be substantially similar to puncture resistant ply 180 described above with respect to FIG. 1. At least one puncture resistant ply 280 may be formed as a rectangle (not shown). At least one puncture resistant ply 280 may be formed into a loop by abutting or overlapping opposing ends of the rectangle. The abutting or overlapping opposing ends of the rectangle may be attached or unattached to one another. The rectangle may have a width corresponding to an axial width PW (not shown) of at least one puncture resistant ply 280. The rectangle may have a width greater than an axial width PW (not shown) of at least one puncture resistant ply 280 to account for curvature of puncture resistant ply 280. Axial width PW may be the distance from first side 282 to second side 284. The rectangle may have a length corresponding to the circumference of at least one puncture resistant ply 280. The rectangle may have a length that is greater than the circumference of at least one puncture resistant ply 280 in order to allow the opposing ends of at least one puncture resistant ply 280 to overlap when formed into a loop.

At least one puncture resistant ply 280 may be formed as a continuous loop. At least one puncture resistant ply 280 may have radially opposing surfaces. At least one puncture resistant ply 280 may have a radially inner surface (not shown) and a radially outer surface (not shown). At least one puncture resistant ply 280 may have a centerline (not shown) on the radial outer surface and/or on the radial inner surface such that the centerline is spaced an equal distance from each of first side 282 and second side 284.

At least one puncture resistant ply 280 may be made from a fiber reinforcement. The fiber reinforcement may be at least one of: a unidirectional fabric, a woven fabric, and a knitted fabric. The fiber reinforcement may have any orientation of fibers that provides for a mesh structure that allows for both open space between and movement among adjacent fibers. The fiber reinforcement may be selected for at least one of: its strength, its durability, its flexibility, its weight, its density, its adhesion to other materials, its puncture resistance, and the like.

The fiber reinforcement of at least one puncture resistant ply 280 may be used to reinforce another material, such as a polymer. Suitable polymers may include elastomers, such as but not limited to, natural rubbers, synthetic rubbers, and thermoplastic elastomers. The material reinforced by the fiber reinforcement is not limited and may be selected from any material depending upon the needs of the application in accordance with contemporary design, engineering, materials science principles, and the like. The fiber reinforcement may be used to reinforce any material suitable for use in a tire.

At least one puncture resistant ply 280 may be substantially puncture resistant. At least one puncture resistant ply 280 may be made from a fiber reinforcement selected for its flexibility and/or its puncture resistance. At least one puncture resistant ply 280 may be made from a fiber reinforcement having a mesh structure that is sufficiently open to allow the material it reinforces to properly adhere to the mesh structure, while simultaneously being sufficiently closed to prevent objects from penetrating the mesh structure.

At least one puncture resistant ply 280 may include a fiber reinforcement comprising a fiber having a weight in denier having the same values as disclosed above with respect to puncture resistant ply 180.

At least one puncture resistant ply 280 may include a fiber reinforcement comprising a nylon fiber. At least one puncture resistant ply 280 may include a fiber reinforcement comprising nylon 66. At least one puncture resistant ply 280 may include a fiber reinforcement comprising an aramid fiber. At least one puncture resistant ply 280 may include a fiber reinforcement comprising a synthetic fiber. At least one puncture resistant ply 280 may include a fiber reinforcement comprising a natural fiber. At least one puncture resistant ply 280 may include a fiber reinforcement comprising a monofilament fiber. At least one puncture resistant ply 280 may include a fiber reinforcement comprising a multifilament fiber.

At least one puncture resistant ply 280 may include a fiber reinforcement comprising a nylon fiber having a weight as disclosed above with respect to puncture resistant ply 180.

Tire 200 may have at least one nylon ply 290 oriented in tread portion 245 radially outward of at least one puncture resistant ply 280. At least one nylon ply 290 may have axially opposing sides, such as a first side 292 and a second side 294. In one embodiment, first side 292 may terminate axially outward of first side 282. In one embodiment, second side 292 may terminate axially outward of second side 284.

At least one puncture resistant ply 280 may be used as a replacement for a belt (not shown). For example, at least one puncture resistant ply 280 may provide sufficient circumferential reinforcement for tire 200 such that a belt may not be necessary. Such an arrangement of tire 200 may at least one of: save weight, reduce rolling resistance, improve ride comfort, increase durability, improve handling, increase fuel efficiency, and the like.

In one embodiment, tire 200 may have more than one puncture resistant ply 280. In one embodiment, tire 200 may have as many puncture resistant plies 280 as necessary to achieve the desired design goals for tire 200.

At least one puncture resistant ply 280 may provide for puncture resistance of tire 200 in tread portion 245. The position of at least one puncture resistant ply 280 may be modified so as to control the area of tire 200 in which puncture resistance is required. For example, puncture resistance may be required in at least one of: first sidewall portion 205, first shoulder portion 215, second sidewall portion 225, second shoulder portion 235, and tread portion 245.

However, in some cases, it may be important to have puncture resistance only in tread portion 245. For example, it may be possible to safely repair a puncture located in tread portion 245 because the construction of tread portion 245 may be less likely to lead to a catastrophic failure of tire 200 than when punctures occur in other locations of tire 200, such as in the sidewall portions and in the shoulder portions. Consequently, it may not be possible to safely repair a puncture located in the sidewall portions or the shoulder portions of tire 200 because such punctures may be more likely to lead to a catastrophic failure of tire 200. A catastrophic failure of tire 200 may be dangerous to an occupant of a vehicle (not shown), as well as to nearby pedestrians and to occupants of nearby vehicles. Thus, in one embodiment, at least one puncture resistant ply 280 may be positioned so as to provide puncture resistance only in tread portion 245. In one embodiment, at least one puncture resistant ply 280 may not extend into either the shoulder portions or the sidewall portions of tire 200.

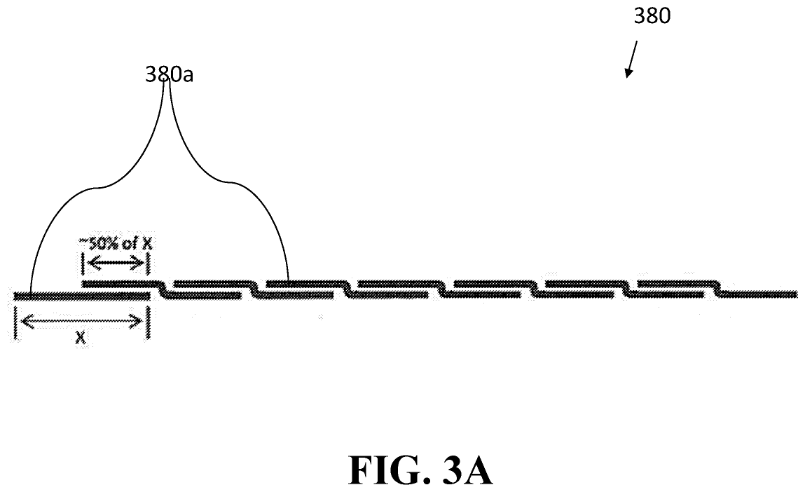

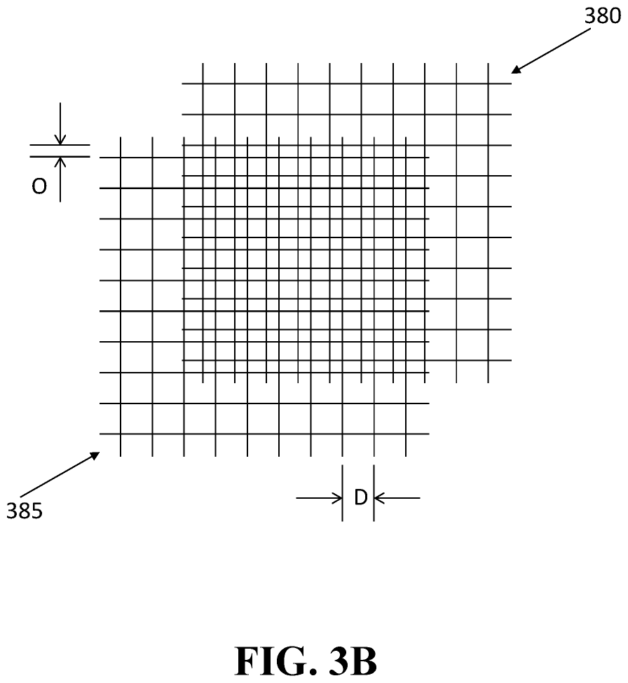

FIG. 3A illustrates a sectional view of an embodiment of a spiral-on puncture resistant ply 380. A tire (not shown) may have at least one puncture resistant ply 380 located in a tread portion (not shown). At least one puncture resistant ply 380 may be oriented radially inward of the tread portion. At least one puncture resistant ply 380 may be oriented radially outward of at least one body ply (not shown).

Puncture resistant ply 380 may have a spiral-on construction such that puncture resistant ply 380 may be spirally wound circumferentially around the tire. That is, puncture resistant ply 380 may be constructed by circumferentially winding a relatively thin strip (i.e., a strip having a width X that is less than the finished width of puncture resistant ply 380) of a fiber reinforcement 380a around the tire during tire construction (e.g., circumferentially around a body ply or a belt of the tire). For example, fiber reinforcement 380a may be applied to a starting point at one axial side of a tire. From the starting point, fiber reinforcement 380a may wind circumferentially around the tire until it returns to the starting point.

When fiber reinforcement 380a is wound completely around the circumference of the tire, it may be referred to as a “first pass” of fiber reinforcement 380a. Subsequently, a second pass of fiber reinforcement 380a may be started, wherein the second pass of fiber reinforcement 380a is axially offset from the first pass of fiber reinforcement 380a. The second pass of fiber reinforcement 380a may be axially offset from the first pass of fiber reinforcement 380a by a distance represented as a percentage of the width X of fiber reinforcement 380a. For example, FIG. 3A illustrates a second pass of fiber reinforcement 380a that is offset from a first pass of fiber reinforcement 380a by a distance that is about 50% of width X.

The first pass of fiber reinforcement 380a and the second pass of fiber reinforcement 380a may be referred to as “adjacent passes” of fiber reinforcement 380a. Adjacent passes are adjacent (i.e., consecutively wound) strips of fiber reinforcement 380a that may collectively form puncture resistant ply 380 in a spiral-on construction. Thus, a third pass of fiber reinforcement 380a may be adjacent to both the second pass and a fourth pass, but the third pass would not be adjacent to any other passes.

Adjacent passes of fiber reinforcement 380a may be axially offset from one another by a distance relative to width X. Adjacent passes of fiber reinforcement 380a may be offset by a distance between 0% (or about 0%) of width X and 100% (or about 100%) of width X. For example, adjacent passes of fiber reinforcement 380a may be offset by any number of distances relative to width X, including but not limited to, 10% (or about 10%), 20% (or about 20%), 37% (or about 37%), 66.67% (or about 66.67%), 75% (or about 75%), 90% (or about 90%), and the like. In one embodiment, adjacent passes of fiber reinforcement 380a may be offset by a distance of 50% (or about 50%) of width X.

The axially offset distance of adjacent passes of fiber reinforcement 380a may be selected in order to optimize various properties of the tire, including but not limited to, puncture resistance, rolling resistance, weight, stiffness, flexibility, durability, and the like. For example, the axially offset distance of adjacent passes of fiber reinforcement 380a may be selected to balances puncture resistance with rolling resistance, weight, stiffness, flexibility, durability, and the like.

FIG. 3B illustrates a plan view of an example embodiment of a first puncture resistant ply 380 and a second puncture resistant ply 385 in a tire (not shown). First puncture resistant ply 380 may have fibers oriented in opposing warp and fill directions. Second puncture resistant ply 385 may have fibers oriented in opposing warp and fill directions. The fibers of second puncture resistant ply 385 may be offset from the fibers of first puncture resistant ply 380 in at least one of: a radial direction, a circumferential direction, and an axial direction. The offset between first puncture resistant ply 380 and second puncture resistant ply 385 may be a distance that is less than the distance between adjacent fibers in either first puncture resistant ply 380 or second puncture resistant ply 385.

In one embodiment, offsetting first puncture resistant ply 380 and second puncture resistant ply 385 in at least one of the radial direction, the circumferential direction, and the axial direction may provide additional benefits in at least one of: adhesion and puncture resistance. For example, each of first puncture resistant ply 380 and second puncture resistant ply 385 may have adjacent fibers spaced sufficiently apart to promote excellent adhesion with a polymer. When two puncture resistant plies are offset as illustrated in FIG. 3B, the resulting spaces formed between adjacent fibers of first puncture resistant ply 380 and second puncture resistant ply 385 are smaller than the spaces between adjacent fibers of either of the puncture resistant plies alone. The spacing may be described as a distance D. Thus, the offset O and overlapping arrangement of the puncture resistant plies illustrated in FIG. 3B may promote excellent puncture resistance while achieving better adhesion with the polymer than a single puncture resistant ply having smaller spaces and equal puncture resistance.

In one embodiment, at least one of first puncture resistant ply 380 and second puncture resistant ply 385 may be formed by spiral-on construction as described above. First puncture resistant ply 380 and second puncture resistant ply 385 may represent first and second passes formed by spiral-on construction as described above. That is, adjacent passes may be spaced so as to achieve the desired offset O.

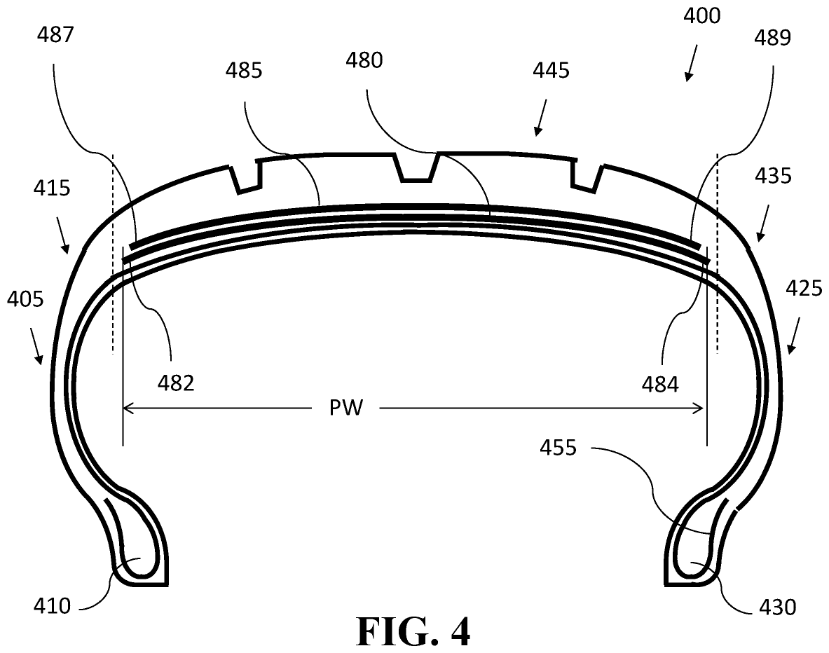

FIG. 4 illustrates a sectional view of an example embodiment of a tire 400. Tire 400 may have a first sidewall portion 405 extending radially from a first bead portion 410 to a first shoulder portion 415. Tire 400 may have a second sidewall portion 425 extending radially from a second bead portion 430 to a second shoulder portion 435. Tire 400 may have a tread portion 445 oriented axially between first shoulder portion 415 and second shoulder portion 435. The junction between tread portion 445 and first shoulder portion 415/second shoulder portion 435 may be denoted for example by a dashed line in FIG. 4.

Tire 400 may have at least one body ply 455 extending radially from at least partially around first bead portion 410, through tread portion 445, to at least partially around second bead portion 430. At least one body ply 455 may wrap at least partially around, approximately half way around, and/or around first bead portion 410 (creating a first turnup portion), extend radially through tread portion 445, and wrap at least partially around, approximately half way around, and/or around second bead portion 430 (creating a second turnup portion). At least one body ply 455 may provide radial reinforcement for tire 400. At least one body ply 455 may provide strength to contain the air pressure within tire 400 and may provide impact resistance in at least one of first sidewall portion 405 and second sidewall portion 425.

Tire 400 may have at least one puncture resistant ply 480 located in tread portion 445. At least one puncture resistant ply 480 may be oriented radially inward of tread portion 445. At least one puncture resistant ply 480 may be oriented radially outward of at least one body ply 455.

At least one puncture resistant ply 480 may have axially opposing sides, such as a first side 482 and a second side 484. First side 482 may terminate axially inward of first shoulder portion 415. Second side 484 may terminate axially inward of second shoulder portion 435.

At least one puncture resistant ply 480 may extend circumferentially around tire 400. At least one puncture resistant ply 480 may be formed as a rectangle (not shown). At least one puncture resistant ply 480 may be formed into a loop by abutting or overlapping opposing ends of the rectangle. The abutting or overlapping opposing ends of the rectangle may be attached or unattached to one another. The rectangle may have a width corresponding to an axial width PW of at least one puncture resistant ply 480. The rectangle may have a width greater than an axial width PW of at least one puncture resistant ply 480 to account for curvature of puncture resistant ply 480. Axial width PW may be the distance from first side 482 to second side 484. The rectangle may have a length corresponding to the circumference of at least one puncture resistant ply 480. The rectangle may have a length that is greater than the circumference of at least one puncture resistant ply 480 in order to allow the opposing ends of at least one puncture resistant ply 480 to overlap when formed into a loop.

At least one puncture resistant ply 480 may be formed as a continuous loop. At least one puncture resistant ply 480 may have radially opposing surfaces. At least one puncture resistant ply 480 may have a radially inner surface and a radially outer surface. At least one puncture resistant ply 480 may have a centerline on the radial outer surface and/or on the radial inner surface such that the centerline is spaced an equal distance from each of first side 482 and second side 484.

At least one puncture resistant ply 480 may be formed as a spiral-on ply of adjacent passes of a fiber reinforcement. The adjacent passes of the fiber reinforcement may be axially offset from one another by a distance relative to a width X of each pass of the fiber reinforcement. Adjacent passes of the fiber reinforcement may be axially offset from one another by a distance relative to width X. Adjacent passes of the fiber reinforcement may be offset by a distance between about 0% of width X and about 100% of width X. For example, adjacent passes of the fiber reinforcement may be offset by any number of distances relative to width X, including but not limited to, 10% (or about 10%), 20% (or about 20%), 37% (or about 37%), 66.67% (or about 66.67%), 75% (or about 75%), 90% (or about 90%), and the like. In one embodiment, adjacent passes of the fiber reinforcement may be offset by a distance of 50% (or about 50%) of width X.

At least one puncture resistant ply 480 may be made from the fiber reinforcement. The fiber reinforcement may be at least one of: a unidirectional fabric, a woven fabric, and a knitted fabric. The fiber reinforcement may have any orientation of fibers that provides for a mesh structure that allows for both open space between and movement among adjacent fibers. The fiber reinforcement may be selected for at least one of: its strength, its durability, its flexibility, its weight, its density, its adhesion to other materials, its puncture resistance, and the like.

The fiber reinforcement of at least one puncture resistant ply 480 may be used to reinforce another material, such as a polymer. Suitable polymers may include elastomers, such as but not limited to, natural rubbers, synthetic rubbers, and thermoplastic elastomers. The material reinforced by the fiber reinforcement is not limited and may be selected from any material depending upon the needs of the application in accordance with contemporary design, engineering, materials science principles, and the like. The fiber reinforcement may be used to reinforce any material suitable for use in a tire.

At least one puncture resistant ply 480 may be substantially puncture resistant. At least one puncture resistant ply 480 may be made from a fiber reinforcement selected for its flexibility and/or its puncture resistance. At least one puncture resistant ply 480 may be made from a fiber reinforcement having a mesh structure that is sufficiently open to allow the material it reinforces to properly adhere to the mesh structure, while simultaneously being sufficiently closed to prevent objects from penetrating the mesh structure.

At least one puncture resistant ply 480 may include a fiber reinforcement comprising a fiber having a weight substantially similar to that of puncture resistant ply 180 described above with respect to FIG. 1.

At least one puncture resistant ply 480 may include a fiber reinforcement comprising a nylon fiber. At least one puncture resistant ply 480 may include a fiber reinforcement comprising nylon 66. At least one puncture resistant ply 480 may include a fiber reinforcement comprising an aramid fiber. At least one puncture resistant ply 480 may include a fiber reinforcement comprising a synthetic fiber. At least one puncture resistant ply 480 may include a fiber reinforcement comprising a natural fiber. At least one puncture resistant ply 480 may include a fiber reinforcement comprising a monofilament fiber. At least one puncture resistant ply 480 may include a fiber reinforcement comprising a multifilament fiber.

At least one puncture resistant ply 480 may include a fiber reinforcement comprising a nylon fiber having a weight substantially similar to puncture resistant ply 180 described above with respect to FIG. 1.

Tire 400 may have at least one nylon ply 490 oriented in tread portion 445 radially outward of at least one puncture resistant ply 480. At least one nylon ply 490 may have axially opposing sides, such as a first side 492 and a second side 494. First side 492 may terminate axially outward of first side 482. Second side 492 may terminate axially outward of second side 484.

At least one puncture resistant ply 480 may be a first puncture resistant ply 480 and a second puncture resistant ply 485. First puncture resistant ply 480 may have fibers oriented in opposing warp and fill directions. Second puncture resistant ply 485 may have fibers oriented in opposing warp and fill directions. The fibers of second puncture resistant ply 485 may be offset from the fibers of first puncture resistant ply 480 in at least one of: a radial direction, a circumferential direction, and an axial direction. The offset (O illustrated in FIG. 3) between first puncture resistant ply 480 and second puncture resistant ply 485 may be a distance that is less than the distance (D illustrated in FIG. 3) between adjacent fibers in either first puncture resistant ply 480 or second puncture resistant ply 485.

First puncture resistant ply 480 and second puncture resistant ply 485 may be used together as a replacement for a belt (not shown). For example, first puncture resistant ply 480 and second puncture resistant ply 485 may provide sufficient circumferential reinforcement for tire 400 such that a belt may not be necessary. Such an arrangement of tire 400 may at least one of: save weight, reduce rolling resistance, improve ride comfort, increase durability, improve handling, increase fuel efficiency, and the like.

Second puncture resistant ply 485 may have axially opposing sides, such as a first side 487 and a second side 489. First side 487 may terminate at about first side 482. First side 487 may terminate axially inward of first side 482. Second side 489 may terminate at about second side 484. Second side 489 may terminate axially inward of second side 484.

Tire 400 may have more than two puncture resistant plies. Tire 400 may have as many puncture resistant plies as necessary to achieve the desired design goals for tire 400.

At least one puncture resistant ply 480 may provide for puncture resistance of tire 400 in tread portion 445. The position of at least one puncture resistant ply 480 may be modified so as to control the area of tire 400 in which puncture resistance is required. For example, puncture resistance may be required in at least one of: first sidewall portion 405, first shoulder portion 415, second sidewall portion 425, second shoulder portion 435, and tread portion 445.

However, in some cases, it may be important to have puncture resistance only in tread portion 445. For example, it may be possible to safely repair a puncture located in tread portion 445 because the construction of tread portion 445 may be less likely to lead to a catastrophic failure of tire 400 than when punctures occur in other locations of tire 400, such as in the sidewall portions and in the shoulder portions. Consequently, it may not be possible to safely repair a puncture located in the sidewall portions or the shoulder portions of tire 400 because such punctures may be more likely to lead to a catastrophic failure of tire 400. A catastrophic failure of tire 400 may be dangerous to an occupant of a vehicle (not shown), as well as to nearby pedestrians and to occupants of nearby vehicles. Thus, in one embodiment, at least one puncture resistant ply 480 may be positioned so as to provide puncture resistance only in tread portion 445. In one embodiment, at least one puncture resistant ply 480 may not extend into either the shoulder portions or the sidewall portions of tire 400.

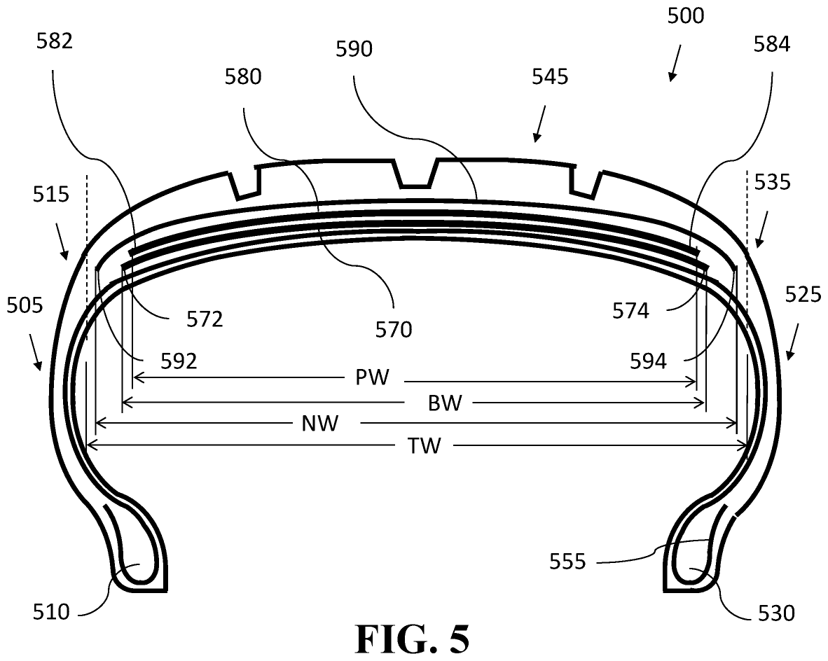

FIG. 5 illustrates a sectional view of an example embodiment of a tire 500. Tire 500 may have a first sidewall portion 505 extending radially from a first bead portion 510 to a first shoulder portion 515. Tire 500 may have a second sidewall portion 525 extending radially from a second bead portion 530 to a second shoulder portion 535. Tire 500 may have a tread portion 545 oriented axially between first shoulder portion 515 and second shoulder portion 535. The junction between tread portion 545 and first shoulder portion 515/second shoulder portion 535 may be denoted for example by a dashed line in FIG. 5.

Tire 500 may have at least one body ply 555 extending radially from at least partially around first bead portion 510, through tread portion 545, to at least partially around second bead portion 530. At least one body ply 555 may wrap at least partially around, approximately half way around, and/or around first bead portion 510 (creating a first turnup portion), extend radially through tread portion 545, and wrap at least partially around, approximately half way around, and/or around second bead portion 530 (creating a second turnup portion). At least one body ply 555 may provide radial reinforcement for tire 500. At least one body ply 555 may provide strength to contain the air pressure within tire 500 and may provide impact resistance in at least one of first sidewall portion 505 and second sidewall portion 525.

Tire 500 may have at least one belt 570. At least belt 570 may located in tread portion 545. At least one belt 570 may be oriented radially outward of at least one body ply 555. At least one belt 570 may extend circumferentially around tire 500.

At least one belt 570 may be an annular reinforcement structure oriented in tread portion 545 and separate from at least one body ply 555. At least one belt 570 may provide reinforcement that is substantially oriented in a circumferential direction. At least one belt 570 may provide reinforcement that is completely oriented in a circumferential direction. At least one belt 570 may have axially opposing sides, such as a first side 572 and a second side 574.

Tire 500 may have at least one puncture resistant ply 580 located in tread portion 545. Puncture resistant ply 580 may be substantially similar to puncture resistant ply 180 described above with respect to FIG. 1. At least one puncture resistant ply 580 may be oriented radially inward of tread portion 545. At least one puncture resistant ply 580 may be oriented radially outward of at least one body ply 555. At least one puncture resistant ply 580 may be oriented radially outward of at least one belt 570.

At least one puncture resistant ply 580 may have axially opposing sides, such as a first side 582 and a second side 584. In one embodiment, first side 582 may terminate axially inward of first shoulder portion 515. In one embodiment, second side 584 may terminate axially inward of second shoulder portion 535.

At least one belt 570 may have an axial width BW greater than an axial width PW of at least one puncture resistant ply 580. First side 572 may terminate axially outward of first side 582. Second side 574 may terminate axially outward of second side 584.

At least one puncture resistant ply 580 may extend circumferentially around tire 500. In one embodiment, at least one puncture resistant ply 580 may be formed as a rectangle (not shown). At least one puncture resistant ply 580 may be formed into a loop by abutting or overlapping opposing ends of the rectangle. The abutting or overlapping opposing ends of the rectangle may be attached or unattached to one another. The rectangle may have a width corresponding to axial width PW. The rectangle may have a width greater than axial width PW to account for curvature in the rectangle. Axial width PW may be the distance from first side 582 to second side 584. The rectangle may have a length corresponding to the circumference of at least one puncture resistant ply 580. The rectangle may have a length that is greater than the circumference of at least one puncture resistant ply 580 in order to allow the opposing ends of at least one puncture resistant ply 580 to overlap when formed into a loop.

At least one puncture resistant ply 580 may be formed as a continuous loop. At least one puncture resistant ply 580 may have radially opposing surfaces. At least one puncture resistant ply 580 may have a radially inner surface and a radially outer surface. At least one puncture resistant ply 580 may have a centerline on the radial outer surface and/or on the radial inner surface such that the centerline is spaced an equal distance from each of first side 582 and second side 584.

At least one puncture resistant ply 580 may be formed as a spiral-on ply of adjacent passes of a fiber reinforcement. The adjacent passes of the fiber reinforcement may be axially offset from one another by a distance relative to a width X of each pass of the fiber reinforcement. Adjacent passes of the fiber reinforcement may be axially offset from one another by a distance relative to width X. Adjacent passes of the fiber reinforcement may be offset by a distance between 0% (or about 0%) of width X and 100% (or about 100%) of width X. For example, adjacent passes of the fiber reinforcement may be offset by any number of distances relative to width X, including but not limited to, 10% (or about 10%), 20% (or about 20%), 37% (or about 37%), 66.67% (or about 66.67%), 75% (or about 75%), 90% (or about 90%), and the like. In one embodiment, adjacent passes of the fiber reinforcement may be offset by a distance of 50% (or about 50%) of width X.

At least one puncture resistant ply 580 may be made from the fiber reinforcement. The fiber reinforcement may be at least one of: a unidirectional fabric, a woven fabric, and a knitted fabric. The fiber reinforcement may have any orientation of fibers that provides for a mesh structure that allows for both open space between and movement among adjacent fibers. The fiber reinforcement may be selected for at least one of: its strength, its durability, its flexibility, its weight, its density, its adhesion to other materials, its puncture resistance, and the like.

The fiber reinforcement of at least one puncture resistant ply 580 may be used to reinforce another material, such as a polymer. Suitable polymers may include elastomers, such as but not limited to, natural rubbers, synthetic rubbers, and thermoplastic elastomers. The material reinforced by the fiber reinforcement is not limited and may be selected from any material depending upon the needs of the application in accordance with contemporary design, engineering, materials science principles, and the like. The fiber reinforcement may be used to reinforce any material suitable for use in a tire.

At least one puncture resistant ply 580 may be substantially puncture resistant. At least one puncture resistant ply 580 may be made from a fiber reinforcement selected for its flexibility and/or its puncture resistance. At least one puncture resistant ply 580 may be made from a fiber reinforcement having a mesh structure that is sufficiently open to allow the material it reinforces to properly adhere to the mesh structure, while simultaneously being sufficiently closed to prevent objects from penetrating the mesh structure.

At least one puncture resistant ply 580 may include a fiber reinforcement comprising a fiber having a weight substantially similar to puncture resistant ply 180 as described with respect to FIG. 1.

In one embodiment, at least one puncture resistant ply 580 may include a fiber reinforcement comprising a nylon fiber. In one embodiment, at least one puncture resistant ply 580 may include a fiber reinforcement comprising nylon 66. In one embodiment, at least one puncture resistant ply 580 may include a fiber reinforcement comprising an aramid fiber. In one embodiment, at least one puncture resistant ply 580 may include a fiber reinforcement comprising a synthetic fiber. In one embodiment, at least one puncture resistant ply 580 may include a fiber reinforcement comprising a natural fiber. In one embodiment, at least one puncture resistant ply 580 may include a fiber reinforcement comprising a monofilament fiber. In one embodiment, at least one puncture resistant ply 580 may include a fiber reinforcement comprising a multifilament fiber.

At least one puncture resistant ply 580 may include a fiber reinforcement comprising a nylon fiber having a weight substantially similar to puncture resistant ply 180 described above with respect to FIG. 1.

Tire 500 may have at least one nylon ply 590 oriented in tread portion 545 radially outward of at least one puncture resistant ply 580. At least one nylon ply 590 may have axially opposing sides, such as a first side 592 and a second side 594. First side 592 may terminate axially outward of first side 582. Second side 592 may terminate axially outward of second side 584.

At least one nylon ply 590 may have an axial width NW. Axial width NW of at least one nylon ply 590 may be greater than axial width BW of at least one belt 570. Axial width BW may be greater than axial width PW of at least one puncture resistant ply 580.

Tread portion 545 may have an axial width TW. Axial width TW of tread portion 545 may be greater than axial width NW of at least one nylon ply 590. The widths of each of tread portion 545 (i.e., TW), at least one nylon ply 590 (i.e., NW), at least one belt 570 (i.e., BW), and at least one puncture resistant ply 580 (i.e., PW) satisfy the relationship TW>NW>BW>PW.

Tire 500 may have an axial centerline. At least one belt 570 may have an axial centerline. At least one puncture resistant ply 580 may have an axial centerline. At least one nylon ply 590 may have an axial centerline. The axial centerline of at least one of: at least one belt 570, at least one puncture resistant ply 580, and at least one nylon ply 590 may be oriented such that the axial centerline is located at about the axial centerline of tire 500. Each of at least one belt 570, at least one puncture resistant ply 580, and at least one nylon ply 590 may be oriented such that the axial centerline of each is located at about the axial centerline of tire 500.

At least one puncture resistant ply 580 may be used as a replacement for at least one belt 570. For example, at least one puncture resistant ply 580 may provide sufficient circumferential reinforcement for tire 500 such that at least one belt 580 may not be necessary. Such an arrangement of tire 500 may at least one of: save weight, reduce rolling resistance, improve ride comfort, increase durability, improve handling, increase fuel efficiency, and the like.

Tire 500 may have more than one puncture resistant ply 580. Tire 500 may have as many puncture resistant plies 580 as necessary to achieve the desired design goals for tire 500.

At least one puncture resistant ply 580 may provide for puncture resistance of tire 500 in tread portion 545. The position of at least one puncture resistant ply 580 may be modified so as to control the area of tire 500 in which puncture resistance is required. For example, puncture resistance may be required in at least one of: first sidewall portion 505, first shoulder portion 515, second sidewall portion 525, second shoulder portion 535, and tread portion 545.

However, in some cases, it may be important to have puncture resistance only in tread portion 545. For example, it may be possible to safely repair a puncture located in tread portion 545 because the construction of tread portion 545 may be less likely to lead to a catastrophic failure of tire 500 than when punctures occur in other locations of tire 500, such as in the sidewall portions and in the shoulder portions. Consequently, it may not be possible to safely repair a puncture located in the sidewall portions or the shoulder portions of tire 500 because such punctures may be more likely to lead to a catastrophic failure of tire 500. A catastrophic failure of tire 500 may be dangerous to an occupant of a vehicle (not shown), as well as to nearby pedestrians and to occupants of nearby vehicles. Thus, in one embodiment, at least one puncture resistant ply 580 may be positioned so as to provide puncture resistance only in tread portion 545. At least one puncture resistant ply 580 may not extend into either the shoulder portions or the sidewall portions of tire 500.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing, which in one embodiment is ±6.35 millimeters (±0.25 inches). To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A pneumatic tire, comprising:
a first sidewall portion extending radially from a first bead portion to a first shoulder portion;
a second sidewall portion extending radially from a second bead portion to a second shoulder portion;
a tread portion oriented axially between the first shoulder portion and the second shoulder portion;
at least one body ply extending radially from at least partially around the first bead portion, through the tread portion, to at least partially around the second bead portion,
wherein the at least one body ply provides radial reinforcement; and
at least one puncture resistant ply located within the tread portion,
wherein the at least one puncture resistant ply is oriented radially outward of the at least one body ply,
wherein the at least one puncture resistant ply comprises at least one continuous puncture resistant strip spirally-wound circumferentially around the at least one body ply,
wherein adjacent passes of the continuous puncture resistant strip are axially offset from one another by a distance of between about 10% and about 90% of their axial widths,
wherein the at least one puncture resistant ply provides circumferential reinforcement, and
wherein the at least one puncture resistant ply includes a fiber reinforcement comprising a fiber having a weight greater than 15 denier.

2. The pneumatic tire of claim 1, wherein the at least one puncture resistant ply has a first side and a second side,
wherein the first side terminates axially inward of the first shoulder portion, and
wherein the second side terminates axially inward of the second shoulder portion.

3. The pneumatic tire of claim 2, further comprising at least one nylon ply oriented in the tread portion radially outward of the at least one puncture resistant ply,
wherein the at least one nylon ply has a first side that terminates axially outward of the first side of the at least one puncture resistant ply, and
wherein the at least one nylon ply has a second side that terminates axially outward of the second side of the at least one puncture resistant ply.

4. The pneumatic tire of claim 1, wherein the fiber reinforcement comprises a fiber having a weight between about 500 denier and about 1500 denier.

5. The pneumatic tire of claim 1, wherein the fiber reinforcement comprises a fiber having a weight between about 700 denier and about 1200 denier.

6. The pneumatic tire of claim 1, wherein the fiber reinforcement comprises either a nylon fiber or an aramid fiber.

7. The pneumatic tire of claim 1, wherein the fiber reinforcement comprises a nylon fiber having a weight of at least one of: about 840 denier and about 1050 denier.

8. The pneumatic tire of claim 1, wherein the at least one puncture resistant ply is a first puncture resistant ply and a second puncture resistant ply;
wherein the first puncture resistant ply comprises fibers oriented in opposing warp and fill directions;
wherein the second puncture resistant ply comprises fibers oriented in opposing warp and fill directions;
wherein the fibers of the second puncture resistant ply are offset from the fibers of the first puncture resistant ply in at least one of: a radial direction, a circumferential direction, and an axial direction; and
wherein the offset between the first puncture resistant ply and the second puncture resistant ply is a distance that is less than the distance between adjacent fibers in either the first puncture resistant ply or the second puncture resistant ply.

9. The pneumatic tire of claim 8, wherein the tire does not have a steel belt extending circumferentially around the tire.

10. A pneumatic tire, comprising:
a first sidewall portion extending radially from a first bead portion to a first shoulder portion;
a second sidewall portion extending radially from a second bead portion to a second shoulder portion;
a tread portion oriented axially between the first shoulder portion and the second shoulder portion;
at least one body ply extending radially from at least partially around the first bead portion, through the tread portion, to at least partially around the second bead portion,
wherein the at least one body ply provides radial reinforcement;
at least one belt located within the tread portion,
wherein the at least one belt is oriented radially outward of the at least one body ply and extends circumferentially around the tire,
wherein the at least one belt provides circumferential reinforcement; and
at least one puncture resistant ply located within the tread portion,
wherein the at least one puncture resistant ply is oriented radially outward of the at least one belt and extends circumferentially around the tire,
wherein the at least one puncture resistant ply comprises at least one continuous puncture resistant strip spirally-wound circumferentially around the at least one belt,
wherein adjacent passes of the continuous puncture resistant strip are axially offset from one another by a distance of between about 10% and about 90% of their axial widths,
wherein the at least one puncture resistant ply provides circumferential reinforcement, and
wherein the at least one puncture resistant ply includes a fiber reinforcement comprising a fiber having a weight greater than 15 denier.

11. The pneumatic tire of claim 10, wherein the at least one puncture resistant ply has a first side and a second side,
wherein the first side terminates axially inward of the first shoulder portion, and
wherein the second side terminates axially inward of the second shoulder portion.

12. The pneumatic tire of claim 11, further comprising at least one nylon ply oriented in the tread portion radially outward of the at least one puncture resistant ply,
wherein the at least one nylon ply has a first side that terminates axially outward of the first side of the at least one puncture resistant ply, and
wherein the at least one nylon ply has a second side that terminates axially outward of the second side of the at least one puncture resistant ply.

13. The pneumatic tire of claim 10, wherein the fiber reinforcement comprises a fiber having a weight between about 500 denier and about 1500 denier.

14. The pneumatic tire of claim 10, wherein the fiber reinforcement comprises a fiber having a weight between about 700 denier and about 1200 denier.

15. The pneumatic tire of claim 10, wherein the fiber reinforcement comprises either a nylon fiber or an aramid fiber.

16. The pneumatic tire of claim 10, wherein the fiber reinforcement comprises a nylon fiber having a weight of at least one of: about 840 denier and about 1050 denier.

17. The pneumatic tire of claim 10, wherein the at least one puncture resistant ply is one puncture resistant ply having a first side axially opposing a second side;
wherein the at least one belt is one belt having a first side axially opposing a second side; and
wherein the first side of the belt terminates axially outward of the first side of the puncture resistant ply, and
wherein the second side of the belt terminates axially outward of the second side of the puncture resistant ply.

18. A pneumatic tire, comprising:
a first sidewall portion extending radially from a first bead portion to a first shoulder portion;
a second sidewall portion extending radially from a second bead portion to a second shoulder portion;
a tread portion having a tread width TW,
wherein the tread portion is oriented axially between the first shoulder portion and the second shoulder portion;
at least one body ply extending radially from at least partially around the first bead portion, through the tread portion, to at least partially around the second bead portion,
wherein the at least one body ply provides radial reinforcement;
at least one belt having a belt width BW,
wherein the at least one belt is located within the tread portion,
wherein the at least one belt is oriented radially outward of the at least one body ply and extends circumferentially around the tire, and
wherein the at least one belt provides circumferential reinforcement;
at least one puncture resistant ply having a width PW,
wherein the at least one puncture resistant ply is located within the tread portion,
wherein the at least one puncture resistant ply is oriented radially outward of the at least one belt and extends circumferentially around the tire,
wherein the at least one puncture resistant ply comprises at least one continuous puncture resistant strip spirally-wound circumferentially around the at least one body ply,
wherein adjacent passes of the continuous puncture resistant strip are axially offset from one another by a distance of between about 10% and about 90% of their axial widths,
wherein the at least one puncture resistant ply provides circumferential reinforcement, and
wherein the at least one puncture resistant ply includes a fiber reinforcement comprising a fiber having a weight greater than 15 denier; and
at least one nylon ply having a width NW,
wherein the at least one nylon ply is located in the tread portion,
wherein the at least one nylon ply is oriented radially outward of the at least one puncture resistant ply and extends circumferentially around the tire.

19. The pneumatic tire of claim 18, wherein each of the at least one belt, the at least one puncture resistant ply, and the at least one nylon ply is oriented such that the axial centerline of each is located at about the axial centerline of the tire.

20. The pneumatic tire of claim 18, wherein the widths of each of the tread portion TW, the at least one nylon ply NW, the at least one belt BW, and the at least one puncture resistant ply PW satisfy the relationship TW>NW>BW>PW.
